(19) United States
(12) Patent Application Publication
(10) Pub. No.: US 2006/0200776 A1
(43) Pub. Date: Sep. 7, 2006

(54) Graphical interface

(75) Inventors: Garr W. Godfrey, Seattle, WA (US); Dave J. Ryan, Seattle, WA (US)

Correspondence Address: STEVEN C. STEWART;REALNETWORKS, INC., 2601 ELLIOTT AVENUE, SUITE 1000, SEATTLE, WA, 98121, US

(73) Assignee: RealNetworks, Inc.

(21) Appl. No.: 11/073,365

(22) Filed: Mar. 4, 2005

(51) Int. Cl. G06F 9/00

(52) U.S. Cl. 715/769; 715/835; 715/784

(57) ABSTRACT

Embodiments of methods, apparatuses, devices and/or systems associated with a graphical interface are disclosed.

### BACKGROUND

Graphical interfaces exist that provide users with challenges such as those that may test judgment, speed, cognitive recognition and/or physical manipulation.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference to the following detailed description when read with the accompanying drawings in which:

FIG. 1 is a diagram of an embodiment having a graphical interface; and

FIG. 2 is a flowchart of an embodiment.

### DETAILED DESCRIPTION

In the following detailed description, numerous specific details are set forth to provide a thorough understanding of the claimed subject matter. However, it will be understood by those skilled in the art that the claimed subject matter may be practiced without these specific details. In other instances, methods, procedures, components that would be understood by one of ordinary skill have not been described in detail so as not to obscure the claimed subject matter.

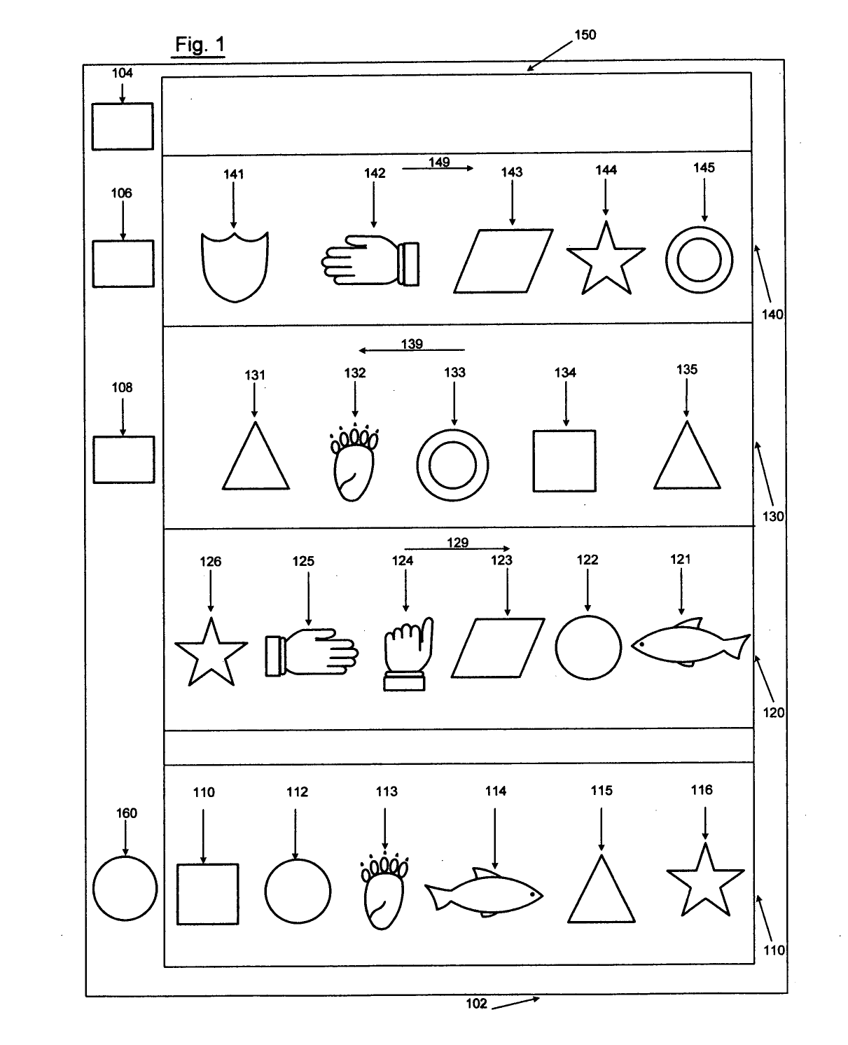

FIG. 1 is a diagram of an embodiment 100, such as a program for example, having a graphical interface 102. In this context, embodiment 100 and/or graphical interface 102 may comprise software, firmware, shareware, freeware, and/or combinations thereof which may be stored in a variety of ways, such as static and/or dynamic random access memory, read-only memory, and/or a hard drive, for example. Additionally, embodiment 100 and/or graphical interface 102 may be downloadable from a computer network, such as an intranet, extranet, and/or a worldwide computer network, for example. Additionally, a storage media, such as, one or more CD-ROMs, re-writable CDs, writable CDs, DVDs, re-writable DVDs, writable DVDs, disks, and/or other storage media now in existence and/or later developed, for example, may have stored thereon instructions, that when executed by a system, such as a computer system, a computing platform, a semiconductor device, a portable computer, a personal digital assistant, and/or other system, for example, may result in an embodiment in accordance with claimed subject matter being executed, such as one of the embodiments described below, for example. As one potential example, a computing platform may include one or more processing units or processors, one or more input/output devices, such as a display and/or a touch screen such as that a user may provide input to the system such as by using a finger, a stylus and/or other pointing device, a keyboard and/or a mouse, and/or one or more memories, such as static random access memory, dynamic random access memory, flash memory, and/or a hard drive, although, again, claimed subject matter is not limited in scope to this example.

With regard to FIG. 1, embodiment 100 may include various information displays such as a score display 104, a high score and/or record score display 106 and/or a time remaining display 106, to name but a few examples. Though the foregoing are merely examples of possible information that can be displayed to a user, many other types and/or pieces of information may be displayed to a user, and claimed subject matter is not limited in this regard. Embodiment 100 may further comprise a first object area 110. First object area 110 may comprise a portion of graphical interface 102 from which a user may pick up and/or manipulate objects individually and/or in multiples, for example, such as for placement into one and/or more openings. In this context an object may comprise a shape having a size and/or a color. In this context an object may further comprise a graphical representation of a shape having a size and/or color. The objects may be displayed against a neutral and/or different colored background, though again this is just an example and claimed subject matter is not limited in this regard. Additionally, objects may be manipulable, such that a user, using graphical interface 102, may pick up and/or move the objects. In this context pick up and/or move comprises selecting an object from first object area 110 and/or moving the object to a different area of graphical interface 102. In this context an opening may comprise a shape having a size and/or opening. In this context an opening may further comprise a graphical representation of a shape having a size and/or color. An opening and/or openings may be graphically displayed against a neutral and/or different colored background, for example. Additionally, openings may be configured such that a user may be able to place an appropriately sized and/or shaped object into an opening. First object area 110 may be configured to display a selected portion of a plurality of objects, such as a square object 111, a circle object 112, an animal footprint object 113, a right facing fish 114 object, a triangle 115 object and/or a star object 116, to name but a few examples. The plurality of objects may be configured such that, as discussed above, a user can select, pick up, and/or move any one of the objects from object area 110 to a different area of graphical interface 102. For example, embodiment 100 may be configured such that a user can pick up and/or place one of the plurality of objects by pointing at the object. In this context pointing may comprise any of a wide variety of activities, such as moving a mouse cursor over the object, and/or clicking on the object with a mouse button while the mouse cursor is over the object, and/or touching the object in the case of a touch screen monitor, and/or touching one of the plurality of objects with a stylus, to name but a few examples. Pointing, may in this context, comprise any activity that indicates selecting one of the plurality of objects, for example. It should be noted, however, that claimed subject matter is not limited in this regard. The plurality of objects may further include additional objects (not shown) that may or may not be displayed to a user. The additional objects may be displayed to a user at a later time. By way of example, a first one of the additional objects may be displayed to a user once a user has picked up one of the displayed selected portion of the plurality of objects, for example. It should be noted that other schemes may be used for showing a user a portion of objects that may be available for placement and that claimed subject matter is not limited in this regard. The additional objects may comprise a shape, such as one of the above mentioned shapes or any of a wide variety of other shapes, which may include variants of the above mentioned shapes as well as any other shape, and/or wild cards, for example. In this context a wild card may comprise an object that may be placed into opening having one and/or more shapes. For example, a wild card may comprise a shape and a size that alter over time, so that the wild card may fit into different shape and/or sized openings at different time. Additionally, a wild card may comprise an object that may be placed into any opening having any shape and/or size, for example. It should be noted that claimed subject matter is in no way limited to any of the particular shapes mentioned above and/or to any particular shapes mentioned below.

Embodiment 100 may further comprise a first openings area 120 which may comprise a portion of graphical interface 102. First opening area 120 may be configured to display a selected portion of a first plurality of openings, which may comprise openings having respective opening shapes, such as a left facing fish opening 121, a circle opening 122, a skewed rectangle opening 123, a right pointing hand opening 125, and/or a star opening 126, for example. In this context, openings may comprise a graphical representation of an opening such as an opening having a first shape and a color shown and/or displayed above and/or against a different color, although, again, it should be noted that claimed subject matter is not limited in this regard. Additionally, openings may be such that a user may interact with the openings, such as by placing an object above and/or into an opening having an appropriate shape, thus effectively filling the opening with the appropriately shaped object, for example. The first plurality of openings may further comprise additional openings which may have a shape such as those mentioned above and/or variants on those mentioned above and/or any other shape. The shapes of the openings may and/or may not correspond to at least one of the above-described object shapes, such that at least one object may or may not be placed into at least one opening, for example.

Embodiment 100 may be configured so that a selected portion of the first plurality of openings may be displayed to a user at any particular moment, for example. Embodiment 100 may be further configured so that the portion of the first plurality of openings that may be displayed to a user may be altered by graphical interface 102 and/or embodiment 100. In this context alter may mean to change, make different; and/or modify in any way. For example, at least one of the displayed openings may be exchanged with another one of the first plurality of openings that may not currently be displayed to a user, so that a user may see a different selected portion of the plurality of openings at different times. By way of example, the first plurality of openings may be organized in a row, wherein a portion of the first plurality of openings may be displayed in graphical interface 102. Alternatively the first plurality of openings may be organized in a column, a diagonal, any other organized scheme and/or no particular arrangement, for example. It should be noted that claimed subject matter is not limited to a particular organization scheme. The row may for example, be scrolled across graphical interface 102 and/or first opening area 120, such as looped in a first direction as indicated by arrow 129, so that the the first plurality of openings may be displayed to a user for a period of time as the opening scrolls across first opening area 120, for example. Additionally, embodiment 100 may be configured such that the rate at which the displayed portion of the first plurality of openings is altered may be made to vary over time. For example, embodiment 100 and/or graphical interface 102 may speed up, slow down, and/or change the direction of the scrolling of the row of objects at determined, calculated, event triggered, random and/or other times and/or time intervals, to name but a few examples. It should be noted that claimed subject matter is not limited in this regard.

Embodiment 100 may further comprise a second openings area 130 which may comprise a portion of graphical interface 102. Second openings area 130 may be configured to display a selected portion of a second plurality of openings, which may comprise openings, such as a triangle opening 131, an animal footprint opening 132, a ring opening 133, a square opening 135, and/or a second triangle opening 136, for example. The second plurality of openings may further comprise additional openings which may have a shape, such as those mentioned above and/or below, and/or variants on those mentioned above and/or below, and/or any other shape. The shapes of the openings may correspond to any one of a number shapes and/or openings including at least one of the above-described object shapes and/or opening shapes, such that at least one object may or may not be placed into at least one of the first and/or second plurality of openings, for example.

Embodiment 100 may be configured so that a selected portion of the second plurality of openings may be displayed to a user at any particular moment, for example. Embodiment 100 may be further configured so that the displayed and/or selected portion of the second plurality of openings may be altered, though claimed subject matter is not limited in this regard. For example, at least one of the displayed selected second plurality of openings may be exchanged with one of the second plurality that is not currently displayed, so that a user may see a different selected portion of the plurality of openings at a different time and/or different times. By way of example, the second plurality of openings may be organized in a row a column, a diagonal, any organized scheme, and/or no particular arrangement, wherein the selected portion of the second plurality of openings may be displayed within graphical interface 102 and/or second openings area 130 at a particular time. The row may then be scrolled across second openings area 130 and/or graphical interface 102, such as looped in a second direction as indicated by arrow 139, so that the second plurality of openings may be displayed to a user for a period of time as the opening scrolls across second openings area 130 and/or graphical interface 102, for example. Additionally, the rate at which the displayed selected portion of the second plurality of openings may vary over a period of time, for example. By way of example, embodiment 100 and/or graphical interface 102 may speed up, slow down, and/or change the direction of the scrolling of the row at determined, calculated, event triggered, random and/or other times and/or time intervals, to name but a few examples. It should be noted that claimed subject matter is not limited in this regard.

Embodiment 100 may further comprise a third openings area 140 which may comprise a portion of graphical interface 102. Third openings area 140 may be configured to display a selected portion of the third plurality of openings, which may comprise openings such as a shield opening 141, a left pointing hand opening 142, a skewed rectangle opening 143, a star opening 144, and/or a second ring opening 145, for example. The third plurality of openings may further comprise additional openings which may have a shape, such as those mentioned above and/or below, variants of those mentioned, and/or any other shape. The shapes of the openings may take any one of a variety of possible shapes, such that at least one object may be placed into at least one opening of the third plurality of openings, for example, although claim subject matter is not limited in this respect. Embodiment 100 and/or graphical interface 102 may be configured so that the selected portion of the third plurality of openings may be displayed to a user at a particular moment, for example.

Embodiment 100 may be further configured so that the selected portion of the third plurality of openings that may be displayed to a user may be altered. For example, at least one of the displayed selected portion of the third plurality of openings may be exchanged with another one of the third plurality of openings that may not currently be displayed, so that embodiment 100 may display a different portion of the third plurality of openings at a different time and/or different times. By way of example, the third plurality of openings may be organized in a row, a column, a diagonal, any organized scheme, and/or no particular organization, wherein the displayed portion of the third plurality of openings may fit within third openings area 140 and/or graphical interface 102. Though it should be noted that claimed subject matter is not limited in this regard. The row may then be scrolled across third openings area 140 and/or graphical interface 102, such as looped in the first direction as indicated by arrow 149, so that the third plurality of openings may be displayed for a period of time as the opening scrolls across third opening area 120 and/or graphical interface 102, for example. Additionally, the selected portion of the third plurality of openings may be altered at varying rates over a period of time, for example. Embodiment 100 may speed up, slow down, and/or change the direction of the scrolling of the row at determined, calculated, event triggered, random and/or other times and/or time intervals, to name but a few examples. It should be noted that claimed subject matter is not limited in this regard.

Embodiment 100 may further be configured to add and/or subtract areas having openings and corresponding pluralities of openings over the course of an interaction with a user and/or a particular user session. For example, embodiment 100 may remove first opening area 110, if, for example, a user fills all and/or some number of the first plurality of openings with correspondingly shaped objects from the first plurality of objects. Additionally, embodiment 100 may further be configured to add and/or subtract opening areas in response to a wide variety of events, such as timer generated events, predetermined events, user generated events, random events, and/or any other events. For example, embodiment 100 may further be configured to add an additional set of openings area at predetermined time intervals while removing sets of openings in response to a user filling that opening area's corresponding plurality of openings with appropriately shaped objects of the first plurality of objects, for example. In that way, if a user does not quickly fill a respective plurality of openings, a space 150 may fill up and/or overflow with sets of openings, which may, in a particular embodiment, end a user interaction and/or session. Embodiment 100 may further be configured to scroll a plurality of rows, a row comprising a plurality of openings, across graphical interface 102 at a particular rate. A user may then have an opportunity to fill the openings before they scroll off screen. By way of example, this may be implemented as a bonus level and/or a normal part of a user session. Though, again, it should be noted, that claimed subject matter is not limited in this regard. Additionally, graphical interface 102 may be configured to provide a user with clues as to where an object should be placed. For example, graphical interface 102 may be configured to highlight openings that may correspond to an object that has been picked up by a user. Though, again, it should be noted that claimed subject matter is not limited in this regard. Additionally, embodiment 100 may further include an object disposal area 160. Object disposal area 160 may allow a user to dispose of an object that the user has picked up without placing the object in a corresponding opening, for example. Object disposal area 160 may allow a user to dispose of an object that does not correspond to any unfilled openings and/or corresponds to an opening that is no longer displayed in graphical interface 102, for example. It should be noted that claimed subject matter is not limited in this regard.

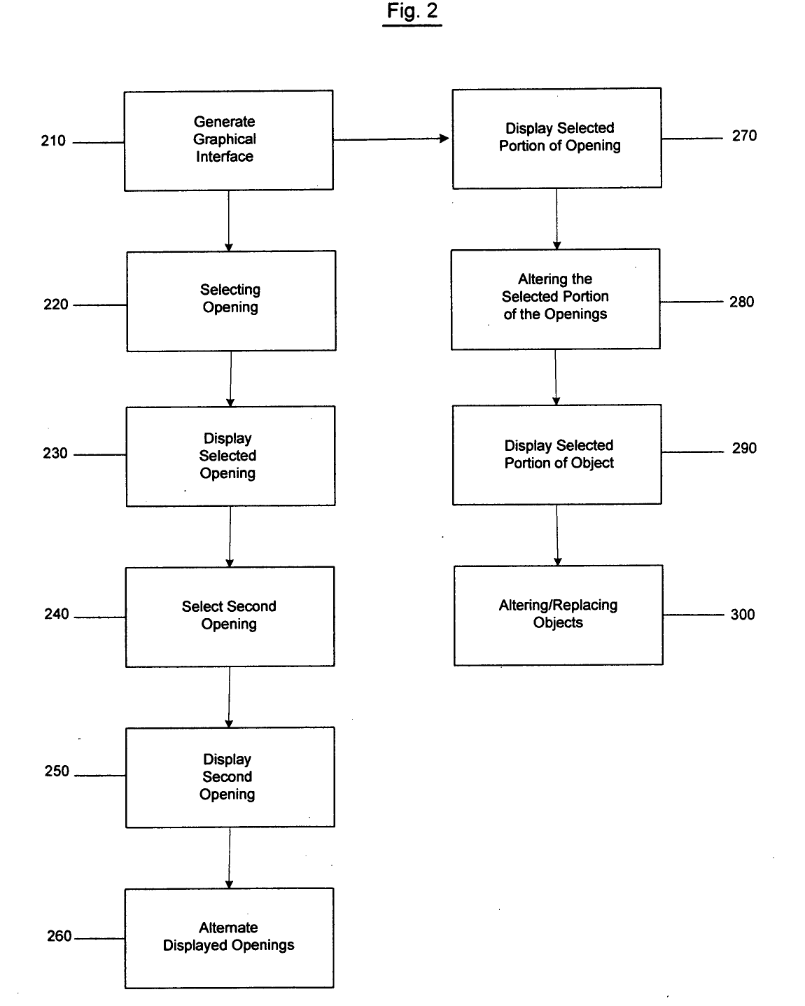

FIG. 2 is a flow chart depiction of an embodiment. With regard to FIG. 2, box 210 depicts generating a graphical interface, such as that described above for example. The graphical interface may be configured to display a selected portion of a plurality of openings. In this context, openings may comprise a graphical representation of an opening such as an opening having a first shape and a color shown and/or displayed above and/or against a different color, although, again, it should be noted that claimed subject matter is not limited in this regard. The openings may have respective opening shapes such as those mentioned above and/or other shapes, for example. Additionally, openings may be such that a user may interact with the openings, such as by placing an object above and/or into an opening having an appropriate shape, thus effectively filling the opening with the appropriately shaped object, for example. The graphical interface may be further configured to display a selected portion of a plurality of objects. In this context an object may comprise a shape having a size and/or a color. In this context an object may further comprise a graphical representation of a shape having a size and/or color. The graphical interface may be further configured to display the objects against a neutral and/or different colored background, though again this is just an example and claimed subject matter is not limited in this regard. Additionally, the graphical interface may be configured such that objects may be manipulable, such that a user, using the graphical interface, may pick up and/or move at least one of the objects. In this context pick up and/or move may comprise selecting an object and/or moving the object to a different area of the generated graphical interface. Though, again this is just an example and the claimed subject matter is not limited in this respect.

With regard to box 220, and/or box 230, the graphical interface may be further configured to select and/or display at least one of said plurality of openings. With regard to box 240 and/or box 250, the graphical interface may be further configured to select and/or display a second at least one of said plurality of openings. With regard to box 260, the graphical interface may be further configured to alternate between displaying the at least one of said plurality of openings and the second at least one of the plurality of openings.

Additionally, with regard to box 270, the graphical interface may be further configured to display a selected portion of the plurality of openings. The selected portion of the plurality of openings may be displayed in a wide variety of manners, such as in a column and/or columns, a row and/or rows, diagonals, any other organized configuration, and/or no particular arrangement at all. With regard to box 280, the graphical interface may be further configured to alter the selected portion of the plurality of openings that are displayed. The graphical interface may alter the selected portion of the plurality of openings in any number of a wide variety of ways, such as, by scrolling a row and/or column across the graphical interface, randomly substituting at least one of the displayed plurality of openings for a displayed and/or non-displayed one of the plurality of openings, and/or any other way of changing the selected portion of the plurality of openings that are displayed, for example. It should be noted that claimed subject matter is not limited in this respect. Additionally, with regard to box 290, the graphical interface may be configured to display a selected portion of the plurality of objects. With regard to box 300, the graphical interface may be further configured to alter the portion of the plurality of objects that is displayed. For example, the graphical interface may be configured to replace a displayed object with a non-displayed one of the plurality of objects once a user has selected the displayed object. Additionally, the graphical interface may be further configured to alter the displayed objects by randomly exchanging displayed objects for non-displayed objects, scrolling all objects across the graphical interface such that the objects are available for selection for a period of time, and/or any of a wide variety of other schemes for altering the displayed portion of the plurality of objects.

It will, of course, also be understood that, although particular embodiments have just been described, claimed subject matter is not limited in scope to a particular embodiment or implementation. For example, one embodiment may be in hardware, such as implemented on a device or combination of devices, as previously described, for example. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, or other system, for example, may result in an embodiment of a method, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, claimed subject matter is not limited in scope to this example.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A graphical interface comprising:
a plurality of objects having respective object shapes;
a first plurality of openings having respective opening shapes, wherein at least one of the object shapes corresponds to at least one of the opening shapes; and
said interface configured to display a selected portion of said plurality of objects and a selected portion of said plurality of openings, said interface further configured such that a user can move at least one of said selected portion of said plurality of objects over at least one of said selected portion of said first plurality of openings.

2. The interface of claim 1, wherein said interface is further configured to alter said selected portion of said first plurality of openings as time progresses.

3. The interface of claim 2, wherein said interface is further configured to display said selected portion of said first plurality of openings by scrolling said first plurality of openings across a display such that a selected number of said first plurality of openings will be displayed at a given time.

4. The interface of claim 3, and further comprising a second plurality of openings, wherein said second plurality of openings have respective opening shapes and at least one of the opening shapes corresponds to at least one of the object shapes.

5. The interface of claim 4, wherein said user interface is further configured to display a selected portion of said second plurality of openings, and wherein said interface is further configured to alter said selected portion of said second plurality of openings.

6. The interface of claim 5, wherein said user interface is further configured to alter said selected portion of said second plurality of openings by scrolling said second plurality of openings across said display such that a selected number of said second plurality of openings will be displayed at a given time.

7. The interface of claim 6, wherein said interface is further configured to scroll said first plurality of openings in a first direction and said second plurality of openings in a second direction.

8. A method comprising:
generating a graphical interface, wherein said interface is configured to display a selected portion of a plurality of openings having respective opening shapes and a selected portion of a plurality of objects having respective object shapes, and wherein said interface is further configured such that a user may move at least one of said plurality of objects over said plurality of openings.

9. The method of claim 8, wherein at least one of the object shapes and at least one of the opening shapes are such that said at least one of said plurality of objects at least in part fits into at least one of said plurality of openings.

10. The method of claim 9, and further comprising selecting at least one of said plurality of openings and displaying the selected at least one of said plurality of openings with said interface.

11. The method of claim 10, and further comprising selecting a second at least one of said plurality of openings and displaying the selected second at least one of said plurality of openings with said interface.

12. The method of claim 11, and further comprising alternating between displaying said first selected at least one of said plurality of openings and displaying said second at least one of said plurality of openings with said interface.

13. The method of claim 10, and further comprising displaying said selected portion of said plurality of openings by scrolling said plurality of openings across said user interface such that a selected number of said plurality of openings will be displayed.

14. The method of claim 13, and further comprising displaying a selected portion of said objects with said interface.

15. The method of claim 14, and further comprising replacing at least one of said selected portion of said objects after said one of said selected portion of said objects has been selected by a user.

16. An article comprising: a storage media having stored thereon instructions that when executed result in:
generating a graphical interface, wherein said interface is configured to display a selected portion of a plurality of openings having respective opening shapes and a selected portion of a plurality of objects having respective object shapes, and wherein said interface is further configured such that a user may move at least one of said plurality of objects over said plurality of openings.

17. The article of claim 16, wherein at least one of the object shapes and at least one of the opening shapes are such that said at least one of said plurality of objects at least in part fits into at least one of said plurality of openings.

18. The article of claim 17, wherein said instructions when executed further result in selecting at least one of said plurality of openings.

19. The article of claim 18, wherein said instructions when executed further result in displaying the selected at least one of said plurality of openings with said interface.

20. The article of claim 19, wherein said instructions when executed further result in selecting a second at least one of said plurality of openings.

21. The article of claim 20, wherein said instructions when executed further result in displaying the selected second at least one of said plurality of openings.

22. The article of claim 21, wherein said instructions when executed further result in alternating between displaying said first selected at least one of said plurality of openings and displaying said second at least one of said plurality of openings.

23. The article of claim 18, wherein said instructions when executed further result in displaying said selected portion of said plurality of openings by scrolling said plurality of openings across said interface such that at least a portion of said openings will be displayed.

24. The article of claim 23, wherein said instructions when executed further result in displaying a selected portion of said objects with said interface.

25. The article of claim 24, wherein said instructions when executed further result in replacing at least one of said selected portion of said objects after said one of said selected portion of said objects has been selected by a user.

26. A system comprising:
means for displaying a portion of a plurality of objects having respective objects shapes;
means for displaying a portion of a plurality of openings having respective opening shapes; and
means for allowing a user to select one of said plurality of objects and place the selected one of said plurality of objects into one of the displayed plurality of openings having a respective opening shape corresponding to said selected one of said plurality of objects.

27. The system of claim 26, and further comprising a means for altering the displayed portion of said plurality of objects.

28. The system of claim 27, and further comprising a means for displaying a portion of a second plurality of openings having respective openings shapes.

29. The system of claim 28, and further comprising a means for altering the selected portion of said second plurality of openings.

30. The system of claim 29, and further comprising a means for allowing a user to select one of said plurality of objects and place the selected one of said plurality of objects into one of the displayed second plurality of openings.

31. A graphical interface comprising:
multiple shaped openings, at least one of said openings changing position as time progresses; and
multiple shaped objects, at least one of said objects capable of filling at least one of said multiple shaped openings.

32. The graphical interface of claim 31, wherein said graphical interface is configured to display a selected portion of said multiple shaped openings at a given time.

33. The graphical interface of claim 32, wherein said graphical interface is configured to display a selected portion of said multiple shaped objects.

34. The graphical interface of claim 33, wherein said graphical interface is further configured such that at least one of said multiple opening may be filled by at least one of said multiple shaped objects.
